(19) United States
(12) Patent Application Publication
(10) Pub. No.: US 2025/0057106 A1
(43) Pub. Date: Feb. 20, 2025

(54) TRAINING PADS

(71) Applicant: EZ Tie Pads LLC, Stamford, CT (US)

(72) Inventor: Marcus De Marchi Lotufo, Stamford, CT (US)

(73) Assignee: EZ Tie Pads LLC, Stamford, CT (US)

(21) Appl. No.: 18/803,998

(22) Filed: Aug. 14, 2024

Related U.S. Application Data
(60) Provisional application No. 63/520,024, filed on Aug. 16, 2023.

(51) Int. Cl. A01K 1/01

(52) U.S. Cl. CPC A01K 1/0107

(57) ABSTRACT

A training pad is disclosed. The training pad comprises a first layer and a second layer superimposed over the first layer. The second layer is adapted to collect waste. Further, the training pad comprises at least one string integrated along a circumference of the first layer. The at least one string is adapted to be pulled by a user to conceal the waste inside the second layer. Further, the training pad comprises at least one release tape affixed underneath to the first layer, and adapted to tear off for releasing the waste collected, from the first layer and the second layer.

### CROSS REFERENCE TO RELATED APPLICATION

This application is a US non-provisional application which claims the priority benefit of the filing date of U.S. Provisional Application Ser. No. 63/520,024, filed 16 Aug. 2023, the entire disclosures of which are incorporated herein by reference.

### FIELD OF THE DISCLOSURE

The invention relates to an absorbent pad. More particularly, the invention relates to a training pad for animals and humans.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art.

Training pads are absorbent pads used to aid in training process for both humans and animals. The training pads are used for housebreaking puppies or for dogs that are left alone for extended periods. They are also used for elderly, sick, or incontinent dogs who may not be able to hold their bladder. Further, the training pads can be used by humans who experience urinary incontinence. These training pads provide protection by absorbing urine, collecting waste, and preventing leaks. These training pads are made of absorbent material that traps urine, with a waterproof backing to protect floors. The training pads come in various sizes and absorbency levels, depending on the human's needs. However, disposing of the waste can be unnecessarily difficult and unpleasant. Typically, traditional solution are nasty to clean, as there is often waste on or near edges of the training pad. Also, these waste can be unpleasant to dispose of.

Prior art, for various aspects contained there within, relevant to this disclosure includes US Pat. Publication No. 5031578A to John L. Hammons. US Pat. Publication No. 20090114161 to Paul Carnahan. In each of these prior arts, waste collection apparatus is disclosed for collecting flaccid and fluid impervious materials. However, these prior arts do not provide an ideal solution for collecting and disposing the collected materials in a pleasant and an easier manner.

In particular, reference '578 to Hammons discloses a sorbent “means” or pad for a litter box. The pad includes a top sheet, a back sheet, and a sorbet core split into two portions separated by a longitudinal slit. The slit extends through top sheet and back sheet. This configuration allows the pad to be removed from the litter box, shown in FIG. 4, allowing the non-sorbent granular litter material to fall through the slit into the litter box. The pad has a drawstring handles, shown in FIG. 4, to facilitate removal and handling. The portions absorb urine. The configuration of the pad allows the urine to be removed from the litter box and the non-sorbent granular material to be reused. However, Hammons does not disclose about adhesive or other closure that closes the slit and does not appear to show or reasonably describe a need to provide the slit with a closure.

Reference '161 to Carnahan discloses a waste collection pad configured with a drawstring and an exterior backing sheet. The backing sheet, the bottommost layer of the pad, prevents animal waste product from leaking through the pad. However, Carnahan does not disclose about any slit of incision that can be closed by adhesive or other closure that closes the slit and does not appear to show or reasonably describe a need to provide the slit with a closure.

Given the deficiencies of the prior arts, therefore there is a need for an effective, easy to use training pad that is configured to provide simple solution for collecting waste and disposing the collected waste in a pleasant, easier and in a more hygienic manner.

### SUMMARY OF THE DISCLOSURE

In an example embodiment, a training pad is disclosed. The training pad comprises a first layer. Further, the training pad comprises a second layer superimposed over the first layer and adapted to collect waste. Further, the training pad comprises at least one string integrated along a circumference of the first layer, wherein the at least one string is adapted to be pulled by a user to conceal the waste inside the second layer. Further, the training pad comprises at least one release tape affixed underneath to the first layer, and adapted to tear off for releasing the waste collected, from the first layer and the second layer.

In some embodiments, the first layer corresponds to a plastic layer and the second layer corresponds to an absorbent layer.

In some embodiments, the first layer comprises a rim portion at the circumference of the first layer. In some embodiments, the first layer has a larger diameter than the second layer such that the rim portion extends outwards from the second layer. In some embodiments, the rim portion having a channel and at least two openings being opposite to each other.

In some embodiments, the at least one string is threaded through the channel and at least some portion of the at least one string protrudes out from the at least two openings. In some embodiments, upon pulling the at least one string from the at least two openings, the channel gets tightened around the rim portion to close the first layer and the second layer into a bag to secure the waste.

In some embodiments, an incision is fabricated at a bottom side of the first layer. The at least one release tape is positioned at the bottom side to cover the incision. In some embodiments, upon tearing off the at least one release tape, the incision releases the waste from the first layer and the second layer.

In some embodiments, the at least one release tape is adapted for withstanding weight of the waste collected inside the bag. In some embodiments, the second layer is made up of at least allergen-free or hypoallergic materials. In some embodiments, the allergen-free or hypoallergic materials comprises at least one of natural materials such as organic cotton, and bamboo fiber, synthetic materials such as polypropylene, and super absorbent polymers (SAP), and other hypoallergic materials such as silicon, and Tencel.

In some embodiments, the first layer corresponds to a polyethylene plastic sheet.

In another example embodiment, a method is disclosed. The method comprising superimposing a second layer of a training pad over a first layer of the training pad, wherein the second layer is adapted to collect waste; integrating at least one string along a circumference of the first layer, wherein the at least one string is adapted to be pulled by a user to conceal the waste inside the second layer; and affixing at least one release tape underneath to the first layer, wherein the at least one release tape is adapted to be teared off for releasing the waste collected, from the first layer and the second layer.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1 illustrates a perspective view of a training pad, according to an embodiment of the present disclosure;

FIG. 2 illustrates an exemplary scenario of pulling of at least one string of the training pad, according to an embodiment of the present disclosure;

FIG. 3 illustrates an exemplary scenario of tearing of at least one release tape of the training pad, according to an embodiment of the present disclosure;

FIG. 4 illustrates an exemplary scenario of transforming the training pad into a bag for securing the waste, according to an embodiment of the present disclosure;

FIG. 5 illustrates an exemplary scenario of disposing the waste or the training pad into a bin, according to an embodiment of the present disclosure; and

FIG. 6 illustrates an exemplary scenario of the training pad used by a pet, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

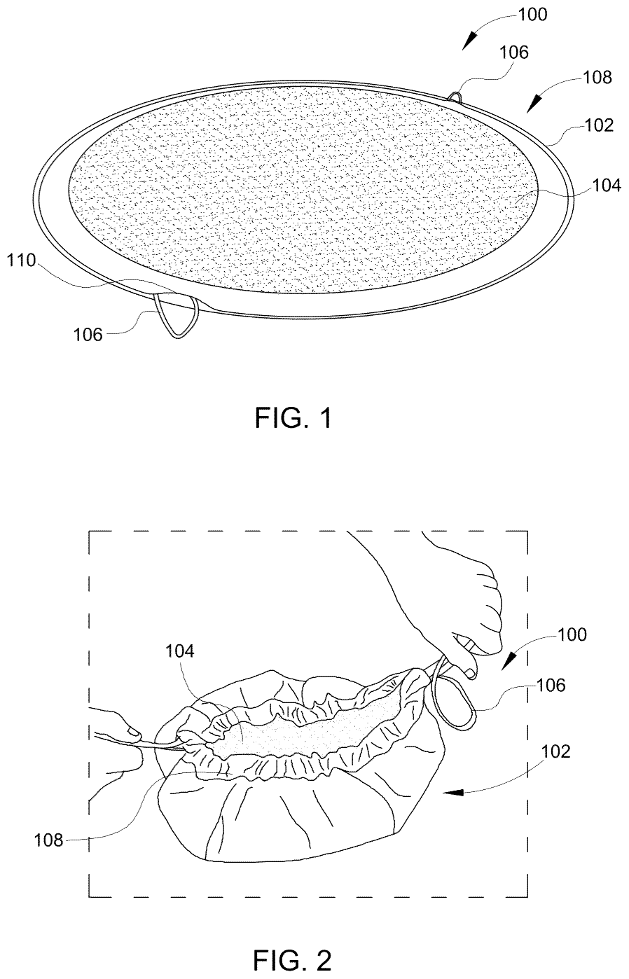

FIG. 1 illustrates a perspective view of a training pad 100, according to an embodiment of the present disclosure. FIG. 2 illustrates an exemplary scenario of pulling of at least one string of the training pad 100, according to an embodiment of the present disclosure.

In some embodiments, the training pad 100 comprises a first layer 102, a second layer 104, and at least one string 106. In some embodiments, the training pad 100 is configured to absorb and collect waste such as liquid waste and solid waste of a pet or a human. The training pad 100 may be placed over a surface such that the pet or the human may use the training pad 100. The training pad 100 is configured in a circular shape and is configured to absorb fluid/liquid waste. The training pad 100 provides an easier and less unpleasant cleanup for a user. In some embodiments, the training pad may be fabricated in shapes other than the circular shape. The shape may include at least one of a square shape, rectangular shape, oval shape etc., without departing from the scope of the disclosure.

In some embodiments, the training pad 100 may comprise the first layer 102 and the second layer 104. In some embodiments, the first layer 102 may correspond to a plastic layer. In some embodiments, the plastic layer may correspond to a polyethylene plastic sheet. In some embodiments, the second layer 104 may be superimposed over the first layer 102. The second layer 104 may correspond to an absorbent layer. In some embodiments, the second layer 104 may be configured to provide a surface for the pet or the human to stand or sit while using. In some embodiments, the second layer 104 may be adapted to collect waste of the pet or the human. In some embodiments, the absorbent layer may be made up of at least allergen-free or hypoallergic materials. In some embodiments, the allergen-free or hypoallergic materials comprises at least one of natural materials such as organic cotton, and bamboo fiber, synthetic materials such as polypropylene, and super absorbent polymers (SAP), and other hypoallergic materials such as silicon, and Tencel.

In some embodiments, the training pad 100 may further comprise at least one string 106. The at least one string 106 may be integrated along a circumference of the first layer 102. In some embodiments, the first layer 102 may have a rim portion 108 at the circumference of the first layer 102. In some embodiments, the plastic layer may have a larger diameter than the absorbent layer such that the rim portion 108 may extend outwards from the absorbent layer. In some embodiments, the rim portion 108 may be fabricated with a channel (not shown). The channel may be hollow cavity fabricated within the rim portion 108. The channel may be configured to thread the at least one string around the rim portion 108.

Further, the rim portion 108 may be fabricated with at least two openings 110. In some embodiments, the at least two openings 110 may be positioned opposite to each other. The at least one string 106 may be configured to protrude out from the at least two openings 110, as shown in FIG. 1. In some embodiments, the at least one string 106 may be adapted to be pulled by the user (as shown in FIG. 2) to conceal the waste (i.e., fluid/liquid waste and the solid waste) collected over the second layer 104. In some embodiments, upon pulling the at least one string 106 from the at least two openings 110, the channel and the rim portion 108 may get tightened to close the first layer 102 and the second layer 104.

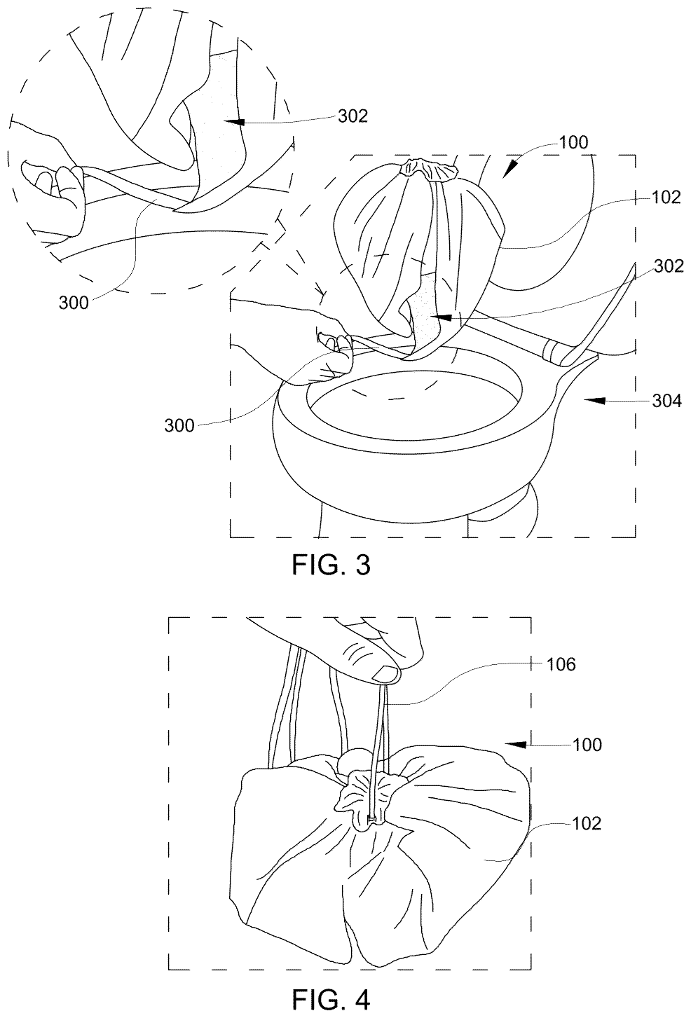

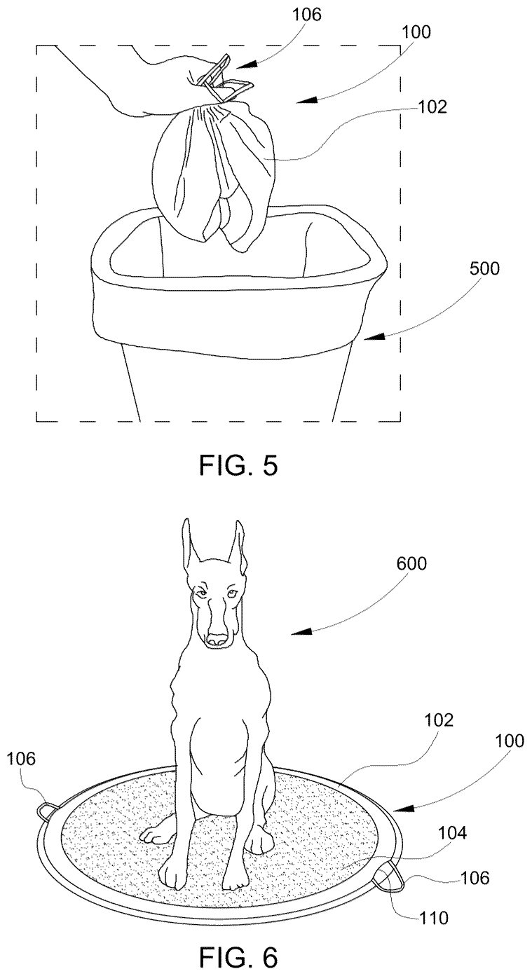

FIG. 3 illustrates an exemplary scenario of tearing of at least one release tape 300 of the training pad 100, according to an embodiment of the present disclosure. FIG. 4 illustrates an exemplary scenario of transforming the training pad 100 into a bag for securing the waste, according to an embodiment of the present disclosure. FIG. 5 illustrates an exemplary scenario of disposing the waste or the training pad 100 into a bin 500, according to an embodiment of the present disclosure.

In some embodiments, the first layer 102 may further comprise the at least one release tape 300. In some embodiments, the at least one release tape 300 may be affixed underneath to the first layer 102 (as shown in FIG. 3). In some embodiments, the at least one release tape 300 may be an adhesive tape that is made up of one or more materials. In some embodiments, the one or more materials may comprise at least one of a polyester, polyethylene, paper. In some embodiments, the at least one release tape 300 may have adhesive coating on at least one side facing the first layer 102. The adhesive coating may be used to affix the at least one release tape 300 underneath to the first layer 102. In some embodiments, the adhesive coating may be pressure-sensitive. The adhesive coating may be made from various materials comprises at least one of acrylics, rubber-based adhesives, or other synthetic compounds, depending on the tape's application. It will be apparent to one skilled in the art that above-mentioned release tape 300 has been provided only for illustration purposes. In some embodiments, a zipper, VELCRO, or any other detachable component that may be affixed underneath to the first layer 102, for securing the waste as well as releasing the waste, without departing from the scope of the disclosure.

In some embodiments, the first layer 102 and the second layer 104 may be fabricated with an incision 302. In some embodiments, the at least one release tape 300 may be configured to cover the incision 302. In some embodiments, the incision 302 may correspond to an opening underneath the first layer 102 and the second layer 104. In some embodiments, the diameter of the incision 302 may be of varied sizes based on application of the training pad 100.

In some embodiments, upon collecting the waste within the second layer 104, the at least one release tape 300 may be adapted to be teared off (as shown in FIG. 3). In some embodiments, the user may be configured to peel off the at least one release tape 300 from one end and slowly release the at least one release tape 300 to open the incision 302. In some embodiments, upon opening the incision 302, the waste may be released out from the training pad 100. In some embodiments, the user may conveniently release the waste into a waste sink 304, as shown in FIG. 3. In some embodiments, the at least one release tape is adapted for withstanding weight of the waste collected inside the bag. As shown in FIG. 4, upon disposing the waste out from the training pad 100, the user may carry the training pad 100 easily from the at least one string 106. Further, the user may carry the training pad 100 towards the bin 500 for disposing the waste or the training pad 100 (as shown in FIG. 5).

FIG. 6 illustrates an exemplary scenario of the training pad 100 used by a pet 600, according to an embodiment of the present disclosure. FIG. 6 is described in conjunction with FIGS. 1-5.

In one exemplary scenario, the training pad 100 may be used by the user for training the pet 600. As shown in FIG. 6, the pet dog may sit over the training pad 100 (i.e., over the second layer 104). In some embodiments, the second layer 104 may be configured to absorb liquid waste with the help of absorbent material. Further, during training of the pet 600, the second layer 104 may be configured to collect the waste. In some embodiments, the user may further be required to dispose the waste easily. In order to dispose the waste, the user may be required to follow the following steps to dispose of the waste within the waste sink 304.

At first, the user may be required to pull the at least one string 106 integrated along the circumference of the first layer 102, to conceal the waste inside the training pad 100. In some embodiments, upon pulling the at least one string 106, the rim portion 108 of the first layer 100 may shrink and form the training pad 100 in the bag. The bag may thereby conceal the waste (i.e., solid and liquid) inside the first layer 102 and the second layer 104 and eliminate any chances of spillage of the waste. Further, the user may tear off the at least one release tape 300 affixed underneath the first layer 102. Tearing off the at least one release tape 300 may open up the incision 302 and allow the user to dispose of the waste. In some embodiments, the user may thus would not require to make close contact with the waste and this may ease out difficulty of disposing the waste of the pet 600.

It will be apparent to one skilled in the art the above-mentioned example of pet 600 has been provided only for illustration purposes. In some embodiments, the training pad 100 may be used by humans or other animals as well, without departing from the scope of the disclosure.

In some embodiments, a method is disclosed for the training pad 100. At first, the second layer 104 is superimposed over the first layer 102 of the training pad 100. In some embodiments, the second layer 104 is configured to absorb and collect the waste. Further, the at least one string 106 is integrated along the circumference of the first layer 102. In some embodiments, the at least one string 106 is adapted to be pulled by the user to conceal the waste inside the second layer 104. Further, the at least one release tape 300 may be configured to be affixed underneath to the first layer 102. In some embodiments, the at least one release tape 300 may be adapted to be teared off for releasing the waste collected from the first layer 102 and the second layer 104.

In some embodiments, the training pad 100 allows for an easier and less unpleasant cleanup. In addition, disposing of the waste is made easy due to the at least one release tape 300. Further, the first layer 102 may be configured to prevent the liquid waste from leaking to the floor where the training pad 100 is placed. In some embodiments, the training pad 100 may make cleaning up of the waste easier and more hygienic for the user. In some embodiments, the training pad 100 is disposable and has a low cost.

It will be apparent to one skilled in the art that the above-mentioned components of the training pad 100 have been provided only for illustration purposes. Further, embodiments of the present invention relate to the training pad 100 that is used for absorbing, collecting and disposing the waste (solid and liquid) of the pet animal or the human, without departing from the scope of the disclosure.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

### LIST OF ELEMENTS

100—Training Pad
102—First Layer
104—Second Layer
106—At least one string
108—Rim Portion
110—At least two openings
300—At least one release tape
302—Incision
304—Waste Sink
500—Bin
600—Pet

What is claimed is:

1. A training pad comprising:
a first layer;
a second layer superimposed over the first layer and adapted to collect waste;
at least one string integrated along a circumference of the first layer, wherein the at least one string is adapted to be pulled by a user to conceal the waste inside the second layer; and
at least one release tape affixed underneath to the first layer, and adapted to tear off for releasing the waste collected, from the first layer and the second layer.

2. The training pad of claim 1, wherein the first layer corresponds to a plastic layer and the second layer corresponds to an absorbent layer.

3. The training pad of claim 1, wherein the first layer comprises a rim portion at the circumference of the first layer.

4. The training pad of claim 3, wherein the first layer has a larger diameter than the second layer such that the rim portion extends outwards from the second layer.

5. The training pad of claim 3, wherein the rim portion having a channel and at least two openings being opposite to each other.

6. The training pad of claim 5, wherein the at least one string is threaded through the channel and at least some portion of the at least one string protrudes out from the at least two openings.

7. The training pad of claim 5, wherein upon pulling the at least one string from the at least two openings, the channel gets tightened around the rim portion to close the first layer and the second layer into a bag to secure the waste.

8. The training pad of claim 1, wherein an incision is fabricated at a bottom side of the first layer, wherein the at least one release tape is positioned at the bottom side to cover the incision.

9. The training pad of claim 8, wherein upon tearing off the at least one release tape, the incision releases the waste from the first layer and the second layer.

10. The training pad of claim 7, wherein the at least one release tape is adapted for withstanding weight of the waste collected inside the bag.

11. The training pad of claim 1, wherein the second layer is made up of at least allergen-free or hypoallergic materials.

12. The training pad of claim 11, wherein the allergen-free or hypoallergic materials comprises at least one of natural materials such as organic cotton, and bamboo fiber, synthetic materials such as polypropylene, and super absorbent polymers (SAP), and other hypoallergic materials such as silicon, and Tencel.

13. The training pad of claim 2, wherein the first layer corresponds to a polyethylene plastic sheet.

14. A method comprising:
superimposing a second layer of a training pad over a first layer of the training pad, wherein the second layer is adapted to collect waste;
integrating at least one string along a circumference of the first layer, wherein the at least one string is adapted to be pulled by a user to conceal the waste inside the second layer; and
affixing at least one release tape underneath to the first layer, wherein the at least one release tape is adapted to be teared off for releasing the waste collected, from the first layer and the second layer.

15. The method of claim 14, wherein the first layer corresponds to plastic layer and the second layer corresponds to an absorbent layer.

16. The method of claim 14, wherein the first layer comprises a rim portion at the circumference of the first layer, wherein the first layer has a larger diameter than the second layer such that the rim portion extends outwards from the second layer, and wherein the rim portion having a channel and at least two openings being opposite to each other.

17. The method of claim 16, wherein the at least one string is threaded through the channel and at least some portion of the at least one string protrudes out from the at least two openings, wherein upon pulling the at least one string from the at least two openings, the channel gets tightened around the rim portion to close the first layer and the second layer into a bag to secure the waste.

18. The method of claim 14, wherein an incision is fabricated at a bottom side of the first layer, wherein the at least one release tape is positioned at the bottom side to cover the incision, wherein upon tearing off the at least one release tape, the incision releases the waste from the first layer and the second layer.

19. The method of claim 17, wherein the at least one release tape is adapted for withstanding weight of the waste collected inside the bag.

20. The method of claim 14, wherein the second layer is made up of at least allergen-free or hypoallergic materials, wherein the allergen-free or hypoallergic materials comprises at least one of natural materials such as organic cotton, and bamboo fiber, synthetic materials such as polypropylene, and super absorbent polymers (SAP), and other hypoallergic materials such as silicon, and Tencel, and wherein the first layer corresponds to a polyethylene plastic sheet.
